(19) United States
(12) Patent Application Publication
(10) Pub. No.: US 2004/0138037 A1
(43) Pub. Date: Jul. 15, 2004

(54) Machine for the production of ready-glued folding boxes arranged in a planar manner

(76) Inventors: Karl-Heinz Kruger, Remscheid (DE); Detlef Hulverscheidt, Dusseldorf (DE)

Correspondence Address: GUDRUN E. HUCKETT DRAUDT, LONSSTR. 53, WUPPERTAL, 42289, DE

(21) Appl. No.: 10/475,124

(22) PCT Filed: Apr. 9, 2002
(86) PCT No.: PCT/EP02/03914

(51) Int. Cl. B31B 9/26

(52) U.S. Cl. 493/79

(57) ABSTRACT

The present invention relates to a machine for manufacturing ready-glued, laid-flat folding boxes of cardboard sheets, preferably of corrugated cardboard, wherein, adjoining the folding and gluing station, a downstream counting and ejecting belt is arranged on which the ready-glued, laid-flat folding boxes are counted and re-stacked in the form of an imbricated flow.

The present invention relates to a machine for manufacturing ready-glued, laid-flat folding boxes according to the preamble of claim 1.

Such machines are known, see, for example, brochure by Kieft.

In principle, such machines, referred to as so-called inline machines, have an intake station for pulling in cardboard sheets that are processed to ready-glued, laid-flat folding boxes according to need in the adjoining processing line.

For this purpose, the ready-glued, laid-flat folding boxes must be stacked again at the end of the machine because the re-stacked folding boxes must be processed automatically, i.e., must be filled, by an adjoining packaging machine.

Important with regard to such inline machines is the optional arrangement of printing devices with which the still laid-flat cardboard sheets are printed as needed as well as the optional arrangement of punching units, for example, for the purpose of punching handles, view holes, or the like into the still laid-flat cardboard sheets.

In order to enable the manufacture of the folding boxes, such machines always have a slitting component with which slits can be produced in the laid-flat cardboard sheets at locations where the bottom or cover flaps are to end.

In a folding and gluing station arranged downstream, the lateral flaps of the still laid-flat cardboard sheets are subsequently folded inwardly by means of a turning device and are glued together in the overlapping zone.

Such inline machines are indeed suitable, in particular, when provided with suitable creasing stations for providing the folding crease and also, in particular, when provided with particularly suitable turning devices, for manufacturing standard folding boxes with extreme precision.

Such inline machines are configured such that the manufacture of ready-glued, laid-flat folding boxes can be completed in a single process.

In the known inline machines, there is however always the problem of precise re-stacking of the ready-glued, laid-flat folding boxes.

For this purpose, as is known in the art, magazines are provided where the sheets are stacked from the top to the bottom or from the bottom to the top and are then ejected.

This is carried out usually by a rearwardly arranged eccentric member of the re-stacking magazine which attempts to align, by means of a vertically positioned alignment plate, the continuously supplied ready-glued, laid-flat folding boxes in a stack.

In this connection, there exists the problem that an alignment is no longer possible in situations where the glue has already set.

Even though by using a thinner glue the setting time can be prolonged without problems, there is still the risk that the boxes, upon impacting on the eccentric member, will open again.

When the boxes moreover are provided with punched-out portions, there is additionally the risk that the ready-glued folding boxes when being re-stacked can easily hook one another so that machine downtimes will result.

This problem is counteracted, as is known in the art, by a stacking process from the top to the bottom. However, this causes a problem in regard to further processing because the lowermost folding box must be pulled out first for further processing.

In order to be complete, it should be noted in this context that the use of printing devices and punching units in such machines is optional with regard to the present invention.

In supplementing this, it should also be mentioned that such inline machines are to be differentiated with regard to so-called folder gluers. In such folder gluers, cardboard sheets are also introduced from a blank stack into the machine.

Even though these folder gluers can produce smallest packages with high precision, they are not designed for an automatic re-stacking because the locally different thicknesses of each individual laid-flat folding box would result in a leaning stack that could be produced practically only manually.

It is therefore an object of the invention to configure the known machines such that they are suitable for automatic re-stacking of automation-suitable packages independent of the thickness of the ready-glued, laid-flat folding boxes.

This object is solved by the invention with the features of the independent claim.

The invention has the advantage that the ready-glued, laid-flat folding boxes that have just been finished are given sufficient time to allow the glue to set in a counting and ejecting unit while, at the same time, an individual alignment of the folding box is enabled.

This advantage is achieved in that the speed of the counting and ejecting unit that is arranged downstream of the folding and gluing station is smaller than the speed at which the pre-processed folded folding boxes leave the folding and gluing station.

In this way, the time required for setting of the glue can also be used for the individual alignment of the folding boxes without this causing the aforementioned problems.

Important in connection with the invention is thus the combination of the known machine for manufacturing ready-glued, laid-flat folding boxes (for example, see brochure by Kieft) with a counting and ejecting belt arranged downstream on which the supplied ready-glued, laid-flat folding boxes are placed in the form of an imbricated flow that is conveyed steadily in the direction toward re-stacking.

For this purpose, the speed of the counting and ejecting belt is smaller than the transport speed of the incoming ready-glued, laid-flat folding boxes.

In addition, the counting and ejecting belt should be aligned in a single continuous transport direction which is uniform for the entire machine. In this way, the longitudinal center lines of the blank stack, slitted boxes, folding boxes, and imbricated flow coincide identically in a vertical plan view.

By means of the arrangement of the folding boxes in the form of an imbricated flow on the counting and ejecting belt, an easily manipulated configuration results in which the individually placed folding boxes can be aligned individually, respectively, while, at the same time, the entire machine has a coinciding transport direction from the blank stack to re-stacking.

In this way, the counting and ejecting belt according to the present invention can be integrated without problems into already existing inline machines. This is realized by simply arranging the counting and ejecting belt downstream of the folding and gluing station.

Since the glued folding boxes, when they reach the re-stacking location, are glued together fixedly and unchangeably, there is also no need for an eccentric device for the purpose of aligning the laid-flat folding boxes in a batch-wise fashion for further processing.

The correlated disadvantages as well as the forced lateral removal from the re-stacked stack are eliminated because the eccentric device is no longer an obstacle in the transport direction.

Moreover, an embodiment is preferred in which the imbricated flow is layered in the transport direction from the top to the bottom.

In this embodiment, the folding boxes that have been previously placed onto the counting and ejecting belt are located at the bottom and are thus loaded additionally by the weight of the subsequently added folding boxes placed on top of them. This measure is beneficial for the fixation of the finished folding box during the setting process of the glue.

In addition, a traveling pressing belt can be arranged above the counting and ejecting belt wherein a spacing between the surface of the counting and ejecting belt and the oppositely located surface of the pressing belt is within the range of the thickness of the imbricated flow in order to be able to exert a sufficient pressure onto the imbricated flow and thus onto the glue joints pointing in the transport direction.

Advantageously, the pressing station is a belt circulating at the same speed as the counting and ejecting belt; the circulating belt is optionally additionally reinforced from the inner side by stationary pressing rails.

In this connection, embodiments illustrating this are provided.

As a result of the reduced speed at which the folding boxes are transported on the counting and ejecting unit, the residence time of the imbricated flow between leaving the folding and gluing station and before reaching the re-stacking device can be adjusted such that at least the setting time of the employed glue is utilized before the laid-flat folding boxes are conveyed into the re-stacking device.

As a function of the speed of the folding and gluing station, an imbricated flow of different height will result in this way so that a selectable spacing between the pressing station and the counting and ejecting unit is beneficial.

For this purpose, the counting and ejecting belt can be provided with a separate drive motor whose rotary speed can be adjusted independent of the motor speed of the folding and gluing station.

On the other hand, a geared-down coupling to the drive of the upstream machine parts is possible.

This special advantage of such inline machines resides in the optional arrangement of additional punching units upstream of the folding and gluing station by means of which cutouts can be punched out of the cardboard sheets.

For this purpose, continuously operating rotary punching units are preferred whose rotation axis extends perpendicularly to the longitudinal center lines of blank stack, slitted boxes, folding boxes, imbricated flow and optionally also the re-stacking stack. With such rotary punching units, the cardboard sheet that has just been processed is conveyed farther at the transport speed during the punching process.

On the other hand, discontinuously operating punching units are also conceivable in connection with the invention, where the cardboard sheets are stationary during the punching process.

An embodiment is provided for this.

In principle, two different speeds for conveying the cardboard articles are sufficient wherein, on the path between the blank stack and the end of the folding and gluing station, a higher speed is set in the transport direction than on the path from the beginning of the counting and ejecting belt to its end.

However, both speeds are continuously constant, respectively, despite their different levels.

In supplementing this, between the intake station, where the cardboard sheets are removed from the blank stack, and the folding and gluing station a printing device can be arranged with which the cardboard sheets, not yet processed, can be printed with single-color or multi-color prints.

The special advantage of the combination according to the invention of a known inline machine with a counting and ejecting belt, arranged downstream and on which the laid flat boxes are guided in the form of an imbricated flow, is the suitability for processing folding boxes of corrugated cardboard which, in this way, can be produced in a single process from the blank stack to the re-stacking stack at high speeds, continuously, and with great precision.

In principle, this advantage is achieved by the individual alignment of all folded boxes in the imbricated flow of the counting and ejecting belt.

In the following, the invention will be explained in more detail with the aid of embodiments. It is shown in:

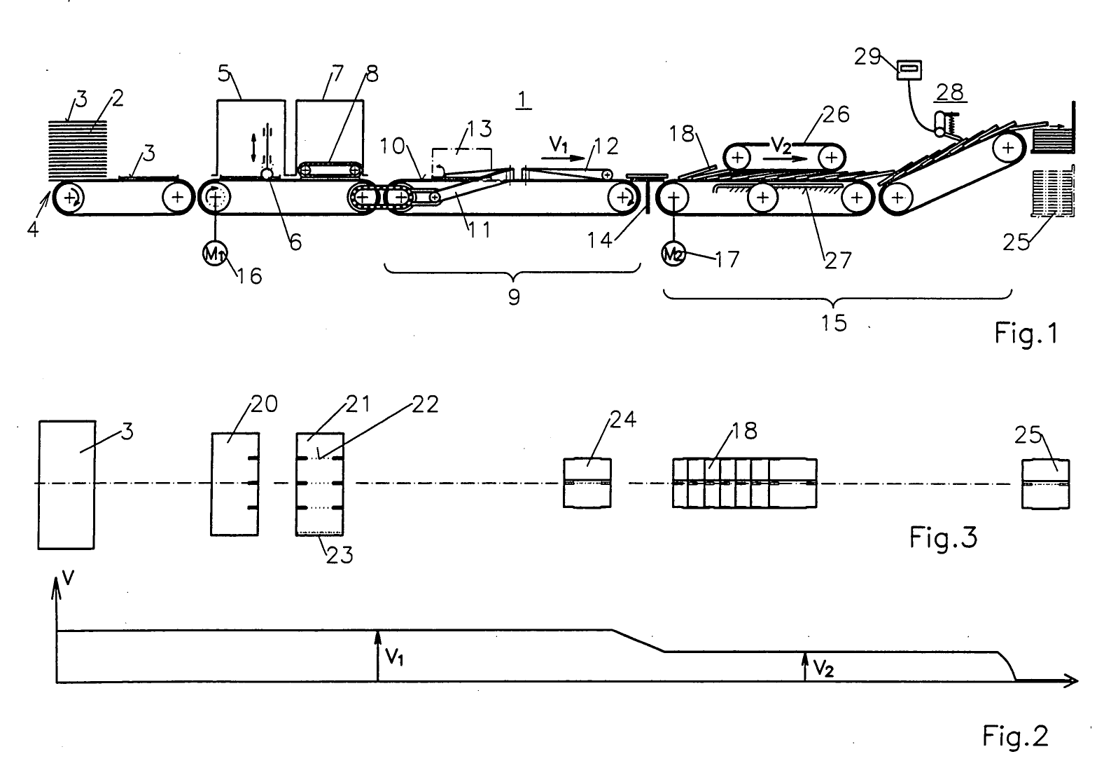

FIG. 1 a first embodiment of the invention in a side view;

FIG. 2 the speed profile during manufacturing on a machine according to FIG. 1;

FIG. 3 the generation of the ready-glued, laid-flat folding box from a cardboard sheet while passing through the machine;

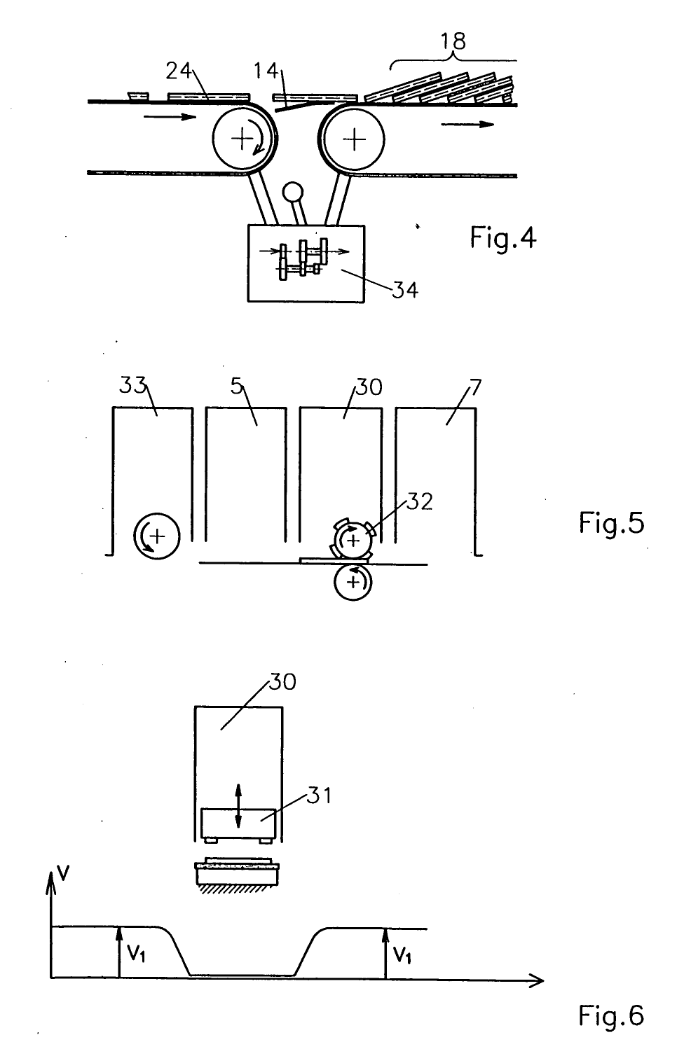

FIG. 4 a rigid gear coupling between the different manufacturing speeds on the folding and gluing station as well as on the counting and ejecting belt;

FIG. 5 the machine components with printing device arranged upstream and punching device (rotary punching unit);

FIG. 6 the use of a flatbed punching unit with stop-and-go operation.

If nothing else is mentioned, the following description concerns all Figures.

The Figures show a machine 1 for manufacturing ready-glued, laid-flat folding boxes. The manufacturing direction extends from the left to the right. Starting with a blank stack 2 comprised of individually stacked cardboard sheets 3, the machine has an intake station 4. Here, the lowermost cardboard sheets are individually pulled out of the blank stack 2, respectively, and sequentially placed onto the processing line of the machine.

In a slitting device 5 arranged downstream, the cardboard sheets 3 are provided with longitudinal slits. For this purpose, a slitting blade 6 is provided which is reciprocated up and down according to a preset program in order to produce the slits in the cardboard sheets.

Subsequently, a creasing station 7 is provided. In this connection, the special feature resides in that creasing is realized by a continuous creasing chain 8 while, simultaneously, the cardboard sheets are continuously transported farther at the transporting speed.

In this way, during the advancing movement of the individual cardboard sheets a constant contact between the creasing chain 8 and the cardboard sheet, respectively, is maintained so that an exactly positioned crease is produced.

Between the conveying belt arranged underneath the slitting component 5 and the creasing station 7, which conveying belt is actuated by the drive motor 16 to perform a continuous movement, and the downstream holding and gluing station 9, a rigid gear connection is provided; this is indicated here by the continuously circulating chain so that in the downstream holding and gluing station 9 the transport belt 10 has the same transporting speed as the transport belt underneath the slitting component 5 and the creasing station 7.

The folding and gluing station 9 has two sequentially arranged turning belts 11 and 12 which are preferably provided with roof ridge shaped projections according to DE-OS 44 12 857. With regard to the details not illustrated here, reference is being had to the entire disclosure of this document.

As a result of this roof ridge shaped projection that extends diagonally across the width of the belt, the inward pivoting of the lateral flaps 13 is guided such that the fishtail effect is prevented in any case. This basic idea with regard to precise manufacturing of such folding boxes belongs also to the contents of this application.

At the end of the folding and gluing station 9, a bridge 14 is provided via which the ready-glued, laid-flat folding boxes are then supplied to the counting and ejecting belt 15.

First, the cardboard sheets 3 are provided in the slitting component 5 with slits that extends longitudinally in the transport direction. Subsequently, in the creasing station 7, a longitudinal crease is provided in the direction of desired folding edges on the cardboard sheets 3, it extends also longitudinally in the transport direction so that in the folding and gluing station 9 arranged downstream the lateral flaps 13 of the folding boxes are folded inwardly along these creases and are glued together along their overlapping zone 23.

Important is the combination of the machine described herein with a counting and ejecting unit 15 arranged downstream for further transport of the incoming ready-glued, laid-flat folding boxes in the form of an imbricated flow 18, wherein the counting and ejecting belt 15 for this purpose is driven at a reduced speed V2 in comparison to the transport speed V1 of the incoming ready-glued, laid-flat folding boxes, wherein additionally, in a vertical plan view, the longitudinal center lines of the blank stack 2, the slitted boxes 20, 21, the ready-glued, laid-flat folding boxes 24, and the imbricated flow 18 coincide identically with one another.

Accordingly, these longitudinal center lines are precisely parallel to the transport direction oriented from the left to the right.

For this purpose, the drive motor 17 is provided on the counting and ejecting belt 15 and is operated at a reduced rotary speed in comparison to the drive motor 16 of the upstream machine.

In particular, FIG. 2 shows the course of the speed across the manufacturing distance. The transport speed of the individual cardboard sheets from the blank stack 2 to the bridge 14 is uniformly constant and indicated at V1. This speed, when crossing the bridge 14, is reduced to the speed V2 present within the counting and ejecting unit 15.

FIG. 3 shows a view from above. A cardboard sheet 3 is comprised of a rectangular tailored blank and is removed from the blank stack 2 at the bottom.

While passing through the slitting station 5, slits are provided in the cardboard sheet 3 transversely to the leading and trailing edges in the transport direction; the slits in the future box are arranged in the corners where the bottom or cover parts are to be folded inwardly.

At the same time, oppositely positioned slits are weakened by the longitudinal creases 22 in the creasing station 8 such that at these locations the inward folding movement of the lateral flaps 13 can be realized in the folding and gluing station 9.

The pre-slitted box 20 now leaves the creasing station 7 as a ready-slitted and creased box 21 before entering the folding and gluing station 9.

Moreover, the ready-creased and slitted box 21 has a gluing fold 23 provided on one of the lateral flaps in order to connect the folded-in box ends along this gluing fold.

The finished and laid-flat folding box 24 leaves subsequently the folding and gluing station 9 and is supplied to the counting and ejecting unit 15.

Since the counting and ejecting unit 15 is moving at a speed that is lower than the speed of the incoming ready-glued and laid-flat folding boxes 24, an imbricated flow 18 results on the counting and ejecting unit 15 where the boxes are deposited in a partially overlapped position from the top to the bottom while they move at the reduced speed V2 through the counting and ejecting unit 15.

Farther downstream, the individual boxes of the imbricated flow 18 are moved onto the re-stacking stack 25 from where they are supplied subsequently to a fully automated packaging machine.

FIG. 1 also shows the arrangement of a pressing station above the counting and ejecting belt 15.

The pressing station is comprised of a pressing belt 26 that moves at the same speed and in the same direction as the conveying belt arranged underneath that is driven directly by the motor 17.

Depending on the speeds of the motors 16 and 17, a different thickness of the imbricated flow 18 results. For this purpose, the spacing of the pressing station from the belt arranged underneath is adjustable. In any case, the spacing should however be within the range of the thickness of the imbricated flow.

At the same time, the residence time of the imbricated flow 18 on the counting and ejecting belt 15 should be at least so great upstream of the re-stacking device 25 as the setting time of the glue that is being used and applied onto the gluing fold 23.

In addition, in the counting and ejecting unit 15 a pressing rail 27 or several such pressing rails may be provided in order to increase the pressing effect on the gluing fold 23 within the folding boxes arranged in the imbricated flow 18.

Downstream of the pressing station, a counting unit 28 is provided. It is comprised of a counting arm resting in a springy fashion on the imbricated flow and being lifted by the leading edge of the following box, respectively, such that a signal is transmitted to the counting display 19.

Subsequently, the finished boxes are stacked on the re-stacking stack 25.

While in FIG. 1 the drive of the counting and ejecting belt 15 is realized by a separately controlled motor 17, whose rotary speed advantageously can be changed like the rotary speed of the motor 16 that realizes the drive of the cardboard sheets 3 to the end of the folding and gluing station 9, it is also possible to provide a geared-down coupling by means of a step-down gear unit 34. This step-down gear unit 34 is illustrated in FIG. 4.

In any case, this is a gear unit whose output speed is smaller than the input speed. Optionally, several gear stages can be provided.

In addition, FIG. 5 shows that, upstream of the folding and gluing station 9, a punching unit 30 is arranged with which cutouts can be punched into the cardboard sheets 3, for example, handles, viewing holes etc.. This is a rotary punch unit 32 whose axis of rotation is perpendicular to the transport direction.

In such rotary punching devices a continuous drive is realized while the individual cardboard sheets pass through it. This is known in the prior art.

As an alternative, FIG. 6 shows a punching unit 31 in which the cardboard sheet 3 is punched in a stop-and-go operation. For this purpose, the cardboard sheet 3 is placed onto the bottom part of the punching bed 31 and is stationary during the punching process. After completion of the punching process, the cardboard sheet 3 is then again subjected to the transport movement.

Also, FIG. 5 shows the special feature that in the forward area of the entire machine a printing device 33 can also be arranged with which the cardboard sheets passing through can be printed by means of a rotating printing roller.

List of Reference Numerals

1 machine for manufacturing folding boxes

2 blank stack

3 cardboard sheet

4 slitting component

6 slitting blade

7 creasing station

8 creasing chain

9 folding and gluing station

10 transport belt

11 upstream turning belt

12 downstream turning belt

13 lateral flap

14 bridge

15 counting and ejecting belt

16 drive motor 1

17 drive motor 2

18 imbricated flow

20 pre-slitted box

21 ready-slitted and creased box

22 longitudinal crease

23 gluing fold

24 ready-glued, laid-flat folding box

25 re-stacking stack

26 pressing belt

27 pressing rail

28 counting unit

29 counting display

30 punching unit

31 punching bed

32 rotary punching device

33 printing device

34 step-down gear

1. A machine (1) for manufacturing ready-glued, laid-flat folding boxes (24) from cardboard sheets (3), wherein first the cardboard sheets (3) of a blank stack (2) are supplied sequentially at an intake station (4) into the processing line of the machine (1) and are provided in a slitting component (5) with slits extending longitudinally in the transport direction, and wherein in a creasing station (7) along desired folding edges (22) a crease is applied to the cardboard sheets (3), which crease also extends longitudinally in the transport direction, so that in a downstream folding and gluing station (9) the lateral flaps (13) of the folding box are folded inwardly along these creases (22) and are glued together at an overlapping zone (23), characterized by the combination with a downstream counting and ejecting belt (15) for further transport of the incoming ready-glued, laid-flat folding boxes (24) in the form of an imbricated flow (18), wherein the counting and ejecting belt (15) for this purpose is driven at a reduced speed (V2) in comparison to the transport speed (V1) of the incoming ready-glued, laid-flat folding boxes (24), and in that, in a vertical plan view, the longitudinal center lines of the blank stack (2), slitted boxes (21), folding boxes (24), and imbricated flow (18) are coinciding identically.

2. The machine according to claim 1, characterized in that downstream of the counting and ejecting belt (15) a re-stacking device (25) is provided.

3. The machine according to claim 2, characterized in that the longitudinal center line of the re-stacking, ready-glued, laid-flat box stack coincides also with the longitudinal center lines of the blank stack (2), slitted boxes (21), folding boxes (24), and imbricated flow (18).

4. The machine according to one of the claims 1 to 3, characterized in that the imbricated flow (18), viewed in the transport direction, is stacked from the top to the bottom.

5. The machine according to one of the claims 1 to 4, characterized in that a pressing station (26) is arranged at a spacing within the range of the thickness of the imbricated flow (18) opposite the counting and ejecting belt (15).

6. The machine according to claim 5, characterized in that the spacing is adjustable to the thickness of the imbricated flow.

7. The machine according to claim 6, characterized in that the pressing station (26) is a circulating belt that is driven at the speed of the counting and ejecting belt (15).

8. The machine according to claim 7, characterized in that the residence time of the imbricated flow (18) on the counting and ejecting belt (15) in front of the re-stacking device (25) is at least as great as the setting time of the employed glue.

9. The machine according to one of the claims 1 to 8, characterized in that the counting and ejecting belt (15) comprises a separate drive motor (17) whose rotary speed is preferably separately adjustable.

10. The machine according to one of the claims 1 to 8, characterized in that the counting and ejecting belt (15) is connected by a geared-down coupling (34) to the drive (16) of the upstream machine components.

11. The machine according to one of the claims 1 to 10, characterized in that upstream of the folding and gluing station (9) a punching unit (30) is arranged with which cutouts are punched out of the cardboard sheets (3).

12. The machine according to claim 11, characterized in that the punching unit (30) operates discontinuously, wherein the cardboard sheet (3) is at rest during the punching step.

13. The machine according to claim 11, characterized in that the punching unit (30) is embodied as a rotary punch (32) having an axis of rotation extending perpendicularly to the longitudinal center lines of the blank stack (2), slitted boxes (21), folding boxes (24), and imbricated flow (18) and that during the punching process the cardboard sheet (3) is transported farther at the transport speed (V1).

14. The machine according to one of the claims 1 to 11, characterized in that the speeds in the transport direction in front of and on the counting and ejecting belt (15) are kept at a continuously constant level, respectively.

15. The machine according to one of the claims 1 to 14, characterized in that, between the intake station (4) and the folding and gluing station (9), a printing device (33) is arranged, preferably a multicolor printing device.

16. The machine according to one of the claims 1 to 15, characterized in that the individual machine components (4, 5, 6, 7, 8, 9, 10, 11, 12, 14, 25, 26, 27, 28) are designed for processing folding boxes (4) from corrugated cardboard.
